(19) United States
(12) Patent Application Publication
(10) Pub. No.: US 2013/0339144 A1
(43) Pub. Date: Dec. 19, 2013

(54) Promotion Management Queue

(71) Applicant: Stanley Kim, San Diego, CA (US)

(72) Inventor: Stanley Kim, San Diego, CA (US)

(21) Appl. No.: 13/919,004

(22) Filed: Jun. 17, 2013

Related U.S. Application Data
(60) Provisional application No. 61/660,732, filed on Jun. 17, 2012.

(51) Int. Cl. G06Q 30/02

(52) U.S. Cl. CPC G06Q 30/0255
USPC 705/14.53

(57) ABSTRACT

The present disclosure provides a system and method for displaying and managing promotions. In a more preferred embodiment, there comprises an online promotion queue displaying and prioritizing relevant promotions to members of an organization or entity.

### CROSS REFERENCE TO RELATED APPLICATIONS

This application claims the benefit under 35 U.S.C. §119(e) to U.S. Provisional Application Ser. No. 61/660,732 filed Jun. 17, 2012.

### FIELD OF THE INVENTION

The present disclosure provides a system and method for displaying and managing promotions. In a more preferred embodiment, there comprises an online promotion queue displaying and prioritizing relevant promotions to members of an organization or entity.

### SUMMARY OF THE INVENTION

The present disclosure provides a system and method for collectively aggregating promotions or advertisements and prioritize the promotions or advertisements.

### BRIEF DESCRIPTION OF THE DRAWINGS

FIG. 1 is a schematic flow diagram of a promotion prioritization queue and method for providing relevant promotions to a user.

FIG. 2 is a flow diagram of a promotion queue for prioritizing a plurality of promotions input from vendors and prioritized and displayed by an entity for an audience.

FIG. 3 is a schematic flow diagram for a system for offering promotions derived by pairing the distinguishable characteristics of the audience of the entity with the target characteristics of the vendor.

FIG. 4 is a flow diagram for a vendor to input promotions to invention queue.

FIG. 5 is a graphical illustration for a user (in this example, a business, although also appropriate for the organization) to identify and choose suitable or desirable partners within a certain range from the user.

FIG. 6 is an exemplary online template for a vendor to input promotions.

FIG. 7 is a flow diagram for an entity to prioritize promotions.

FIG. 8 illustrates an exemplary promotion queue for click-and-drag prioritization of promotions.

FIG. 9 illustrates an exemplary promotion queue for reordering the priorities of promotions.

FIG. 10 is a flow chart for an audience to affect the priority of promotions in the invention queue.

FIG. 11 is a graphical illustration for an audience to select particular promotions.

FIG. 12 is a block diagram illustrating a computer system that is able to perform the invention methods.

FIG. 13 is a diagram illustrating portals for individuals to process the invention queue.

FIG. 14 illustrates the collective aggregation of vendors and/or promotions/advertisement stored on a database that are allocated to recipient network based on matched characteristics.

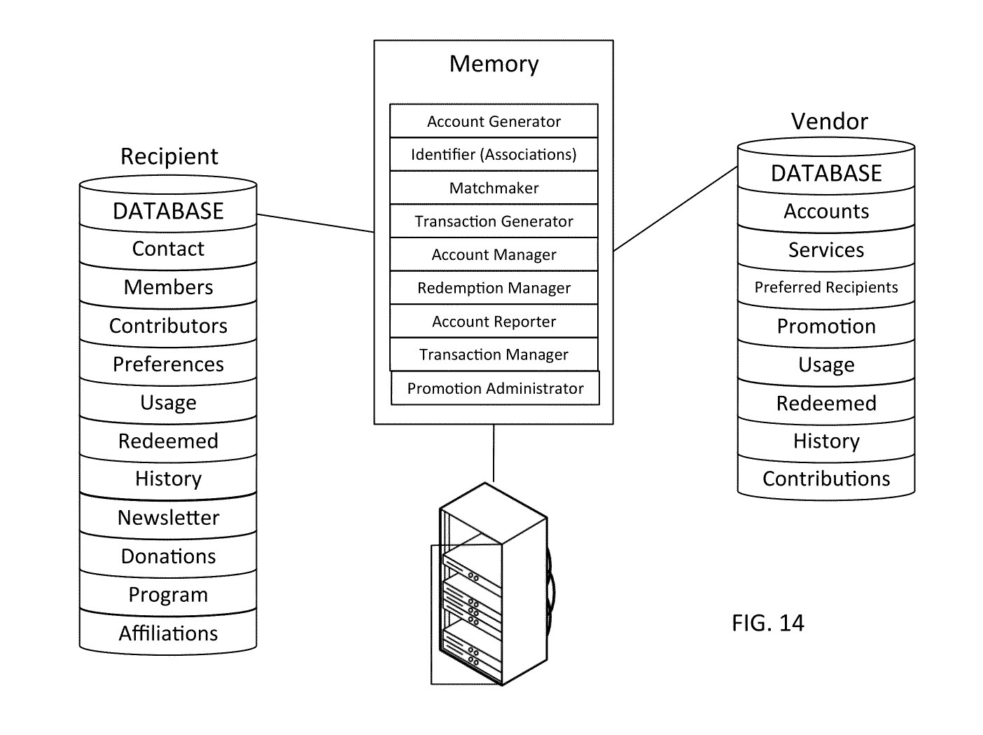

### DETAILED DESCRIPTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well-known features may not have been described in detail to avoid unnecessarily obscuring the invention.

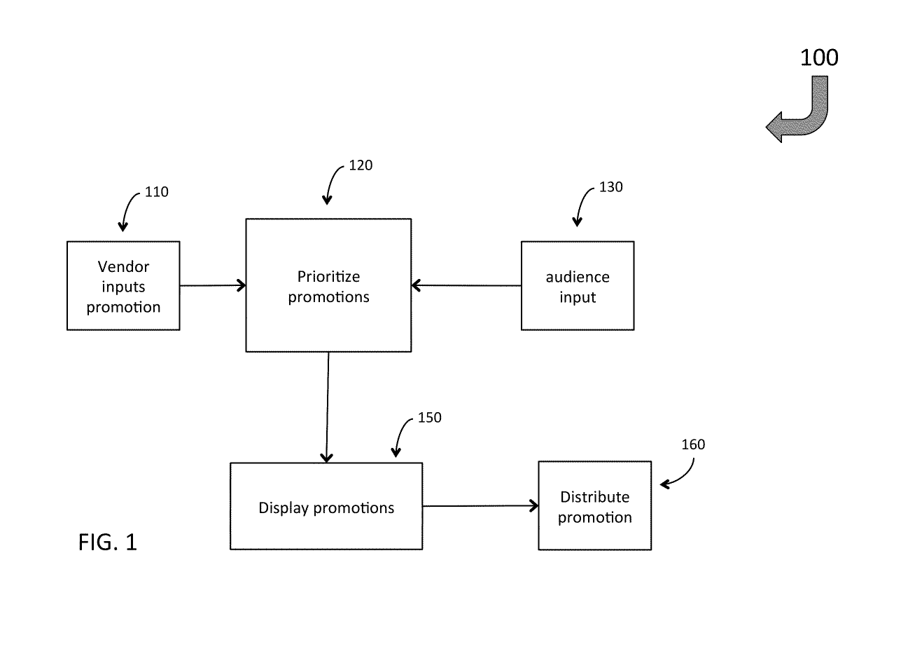

The present disclosure provides a system and method for an online queue system for displaying and prioritizing promotions. The present invention discloses an online system for users to manage and prioritize a plurality of electronic transactions such as promotions that may be of interest to the user or others represented by user, for example a group or entity represented by the user. FIG. 1 illustrates a system 100 for an online queue for prioritizing promotions. As shown in FIG. 1, vendors will provide general information about a promotion 110, which may be provided in detail or in summary form. A summary of the promotion then can be extracted from the vendors input, and aggregated on the invention queue. The invention queue 100 can be displayed visually, graphically or textually 150 to the user of the system. The promotions can be dynamically prioritized 120 based on the various factors including the desires, relevance or interest of the user of the system or a larger audience represented by the user 130. Periodically, or upon certain criteria being met (e.g., minimum number of promotion requests), promotion is distributed 160 to the user or an audience. Information about the promotion such as cost, category, genre, business, history, value, recommendations, requests, analytics, location or proximity, and other direct or indirect factors will affect the priority of the promotion and enable the user of the system to prioritize the promotion. As described herein, prioritization includes the automated or manual management of the promotions to satisfy the desire or requests of the user or the group. In one embodiment, promotions are manually prioritized by the user who manually reorders promotions (for example, one at a time) based on the interest of the user or a larger audience. Alternatively, the order of the promotions can be automatically, for example affected by the desires, relevance or activity (for example, purchasing history) of third parties, e.g., audience, who may who have similar characteristics of the user. Such factors include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), affiliations or relationships (such as membership, alumnus status, parent, grandparent, sibling or other relationship) and the like.

A promotion generally refers to an electronic transaction in which one or more vendors believe they can incentivize consumers to acquire or receive a good, service or product, particularly through advertisement or other marketing inducements. Such inducements are generally for products or services donated, acquired, distributed or shared with participating consumers, including, but not limited to, sales incentives, rebates, vouchers, redeemable gift certificates, coupons, advertisements, donations, raffles, auctions, freebies, discounts, and the like, and particularly include sales incentives such as BOGO (or Buy One (or more) Get One (or more) free/discounted), tiered goods such as pre-fixe products, incentive-based transactions as minimum purchase/donation gifts, discounted gift certificates, discounted coupons, matching programs (e.g., dollar for dollar), in-kind services, and the like. For example, a rental for a movie or DVD may not be considered an incentive unless the actual rental was provided in, for example, a discount or for free.

Ranking a promotion higher generally will make the promotion more relevant, for example, by placing the promotion higher on a list or more visible in a chart. The prioritization can be listed in order from 1, 2, 3, 4, 5 and so on, or grouped together, for example, groups of five or ten. It may list the top five, ten or twenty or such other number of promotions as may be appropriate, desirable or logistical. This list will continually and preferably automatically, prioritize promotions based on the desires of the user of the system, or the intended audience, e.g., users of an organization (generally represented by the user of the system). As further illustrated in FIG. 1, the preferred present invention 100 contemplates a mechanism 120 for the proactive prioritization of promotions to the user, for example, by weighing the input of the intended audience of the promotions. Preferably, such system is adaptive, more preferably self-adaptive (as described further below).

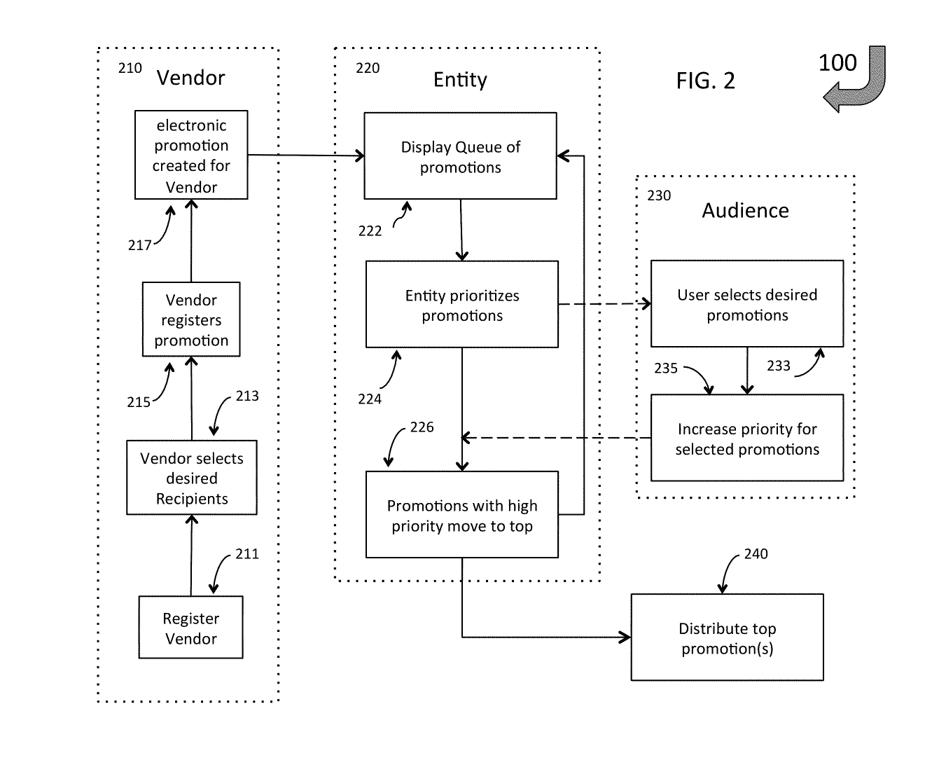

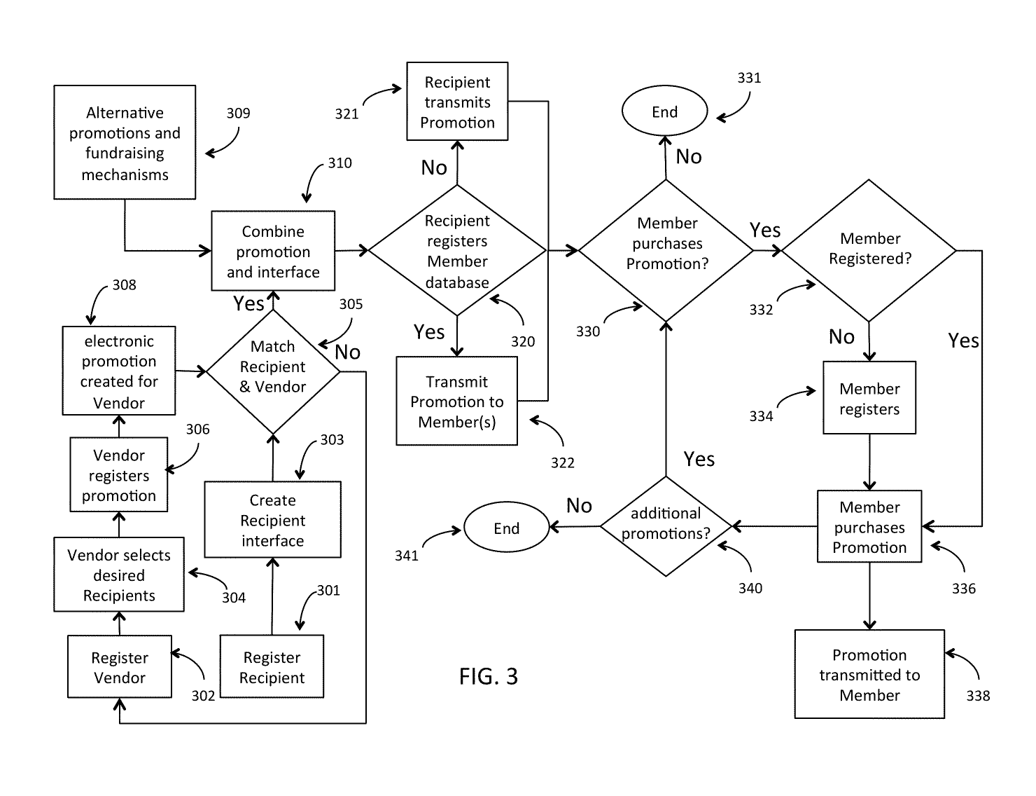

FIG. 2 shows a preferred view of the invention promotion prioritization queue 100, specifically as it applies to an organization or an entity (collectively entity) 220 desiring to provide promotions for its members, stakeholders, donors, volunteers, or other such audience 230. An entity 220 may have a plurality of vendors 210 who desires to partner with the entity 220 to reach the entity's audience (including its member base) 230. The invention queue 100 will display an active list of promotions that match the characteristics or desires of the entity and its users. The invention queue 100 to manage the promotions can also be displayed on multiple platforms. Vendors 210 may register 211 with the system 100 and input its information. Vendor can designate 213 specific entities it desires to promote its services or goods, e.g., promotions. Preferably, as exemplified in FIG. 3, the vendor and entity can match their interests through a system such as that described in U.S. patent application Ser. No. 13/431,899. Promotions can be input manually or automatically into the system 215. Preferably, the promotion is input through a template system 215 to automate the process of adding promotions into the system. Once input, an electronic representation of the promotion is created 217. A list of multiple promotions, particularly promotions matched for the entity, can then be aggregated in the invention queue 100 and displayed 220 for the entity 220, or a representative of the entity, to manage. The entity 220 will be able to manipulate the list of promotions using the invention management system, with one or more relevant or desirable promotions presented to its audience 230. Promotions can be displayed on multiple platforms (described further below) to the entity's audience.

In a preferred process, promotions are preselected prior to being presented in invention queue. They can be selected by the invention system 100 for the user based on relevance to the user, the entity, and/or its audience. For example, promotion will be automatically selected by the system 100 based on location of vendor and recipient. Alternatively, or in addition to location, selection is predetermined based on the registration requests of both parties. Depending on the recipient, an administrator for the recipient may select or disqualify each or group of vendor(s) and/or promotion(s), industries, vendor groups, categories, etc., e.g., certain entities such as schools or churches may not desire liquor stores to participate in their pool of vendors. Most preferably, vendors will register with certain recipients added as their pool of potential recipients, and in parallel, recipients will register with certain vendors or classes of vendors be added as their pool of potential vendors. If promotions are already registered in the system when recipient registers, recipient can select those specific vendors and/or promotions it will qualify or disqualify as recipient's selected vendors. If there are no matches, for example, there are no suitable vendors or promotions suitable in the system, the system will wait until a suitable promotion is available, whereupon the promotion will be integrated into the recipient's queue. Alternatively, or in addition, promotion preselection can be made with other factors in consideration, such as by the input of the members who vote or request certain promotions or types of promotions.

As shown further in FIG. 2, the invention comprises a prioritization engine, wherein promotions are manually or automatically, or semi-automatically prioritized and displayed to the entity (e.g., an administrator) 220. The invention queue 100 will display sufficient information 222 about each promotion for the entity to evaluate the promotion 224, which can be detailed information about the promotion or preferably abridged information about the promotion. Such information can be the business name, the type and location of the business, a summary and/or type of the promotion and rating of the business. Other information may include detailed information of the promotion, limitations or exclusions, range of valid dates or expiration date, cost, value, illustrations, graphics or pictures, history of usage, dates of availability, a marker to move to the top or to remove the promotion, and other such information. The queue can identify each promotion by a ranking system 226, for example, the number ‘1’ to identify the top promotion, ‘2’ to identify the second highest promotion, and so on. The listing of the promotions can be manually moved to the top by a registrant of the entity, for example moving a promotion from the bottom of the top, replacing a lower ranking number with higher ranking number, clicking and dragging a promotion from one position to another, clicking on ‘top’ button, removing or trashing promotions, or such other mechanism to reorganize the listings.

The promotions can also be automatically prioritized based on the usage and desires of third parties, such as the audience 230 of the entity 220. For example, if the audience 230 of the entity is given the right to vote for or choose particular promotions or promotion types 233, the invention queue 100 can automatically adjust the priority of the promotion listings 235 without the manual manipulation of the listing by the entity administrator. Audience can select for businesses, categories, price ranges, proximity or other such factors. The input of the audience 233 can be direct or indirect, for example, the voting of a large audience can be directly attributed to the ranking of the promotions or weighed against other factors such as history, value, recent usage, demand, etc. In one embodiment, voting can be implemented by invention prioritization queue, wherein each audience member accesses an invention prioritization queue to manage their promotions. In addition, the input of the audience 233 can be combined with the manual manipulation of the entity. For example, the entity can identify pools of potential promotions for the audience to prioritize or the audience can identify the pools of potential promotions for the entity to prioritize—e.g., either administrator, or alternatively audience, will prioritize 10 promotions at a time from a pool of thirty which may be selected from the total pool of several hundred. The list of promotions will constantly evolve, with one or more promotions being distributed to the user and/or audience after some time period 240. Distribution 240 can be made on demand by the user or audience, fixed time intervals (e.g., day, several days, week, several weeks, month(s), year, etc.), or other impetus such as a minimum number of purchasers (aka collective bargaining or group purchases). Once a promotion is used, the used promotion can be recycled or expended. Information about usage will be recorded and analyzed for market analysis purposes.

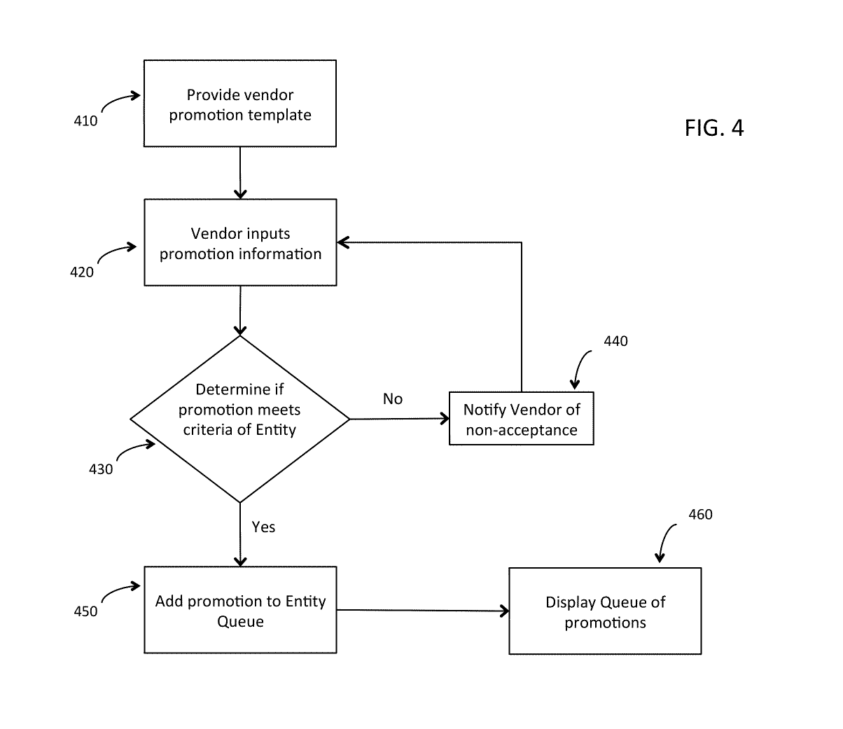

Potential vendors can be automatically invited 410 by system to participate through email, mail, phone or other invitation. Preferably, a plurality of vendors chooses to participate in a fundraising system. Upon registration, each vendor will submit 420 one or more potential promotions for distribution. An electronic representation of such promotions can automatically or manually be created by the system, e.g., by a promotion template filled in by the vendor or other party. In addition, multiple promotions can be input into the system for each vendor. FIG. 4 shows a templated system 410 for a vendor to enter promotions into the system 420.

As shown in FIG. 4, the invention system can provide vendors a template 410 to input information about promotions. The promotions can initially be filtered 430 to remove inappropriate or undesirable characteristics, for example, alcohol or adult themed promotions for children. The filtering 430 can be based on characteristics such as location, price or categories, or such other information similar to those described above that describe the priority of the promotion. Vendor may be notified 440 of the exclusion of its promotion at this point or at any other point that its promotion is not accepted or processed. Once a promotion is accepted, it will be added 450 to the list of promotions to be displayed 460 to a user for further prioritization.

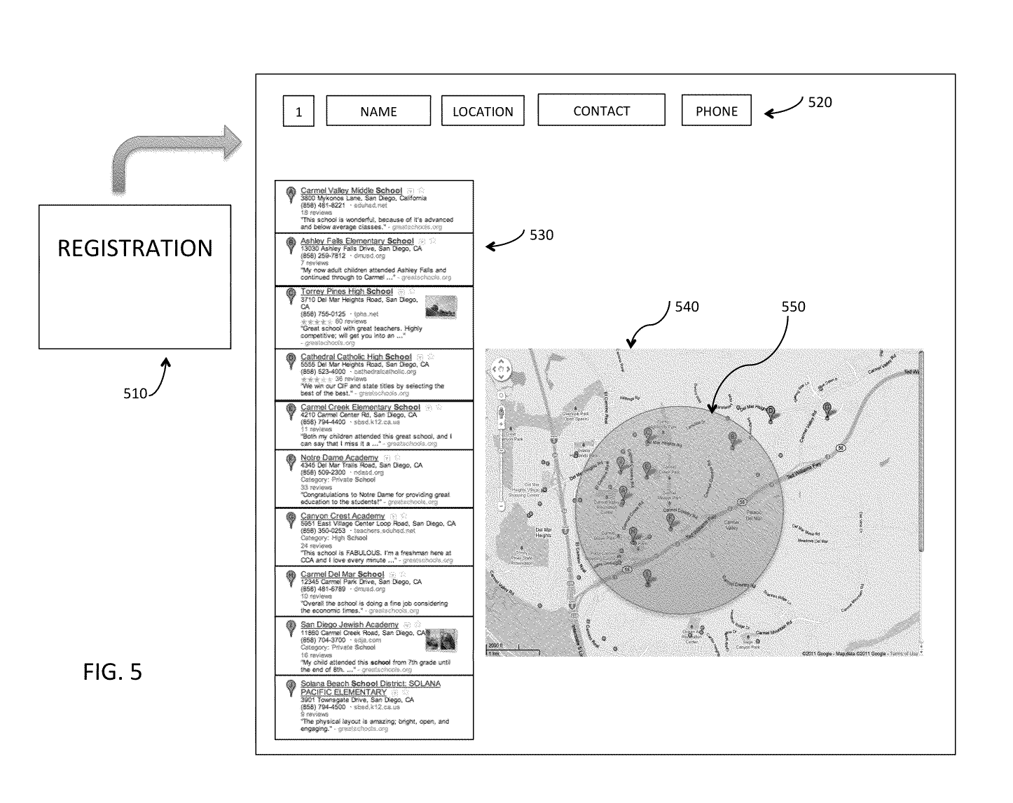

Vendors such as businesses, service providers, shops, manufacturers, restaurants, and the like will register with the system. Vendors can also be individuals selling or reselling services or products. Through the registration process, certain identifying characteristics will be identified such as location and, optionally, target customers of vendor, which can be used to characterize potential partner recipients. General information about the vendor can be used to generate a “picture” of the vendor to be used to promote vendor in system. Such information can include images or descriptions, including name, address, product or service provided, affiliations, membership, interest, demographic member, location or proximity, business interest, or other such information, or other such distinguishable characteristic (as described above). Preferably, the system will identify specific potential target recipients in proximity to vendor (as shown in FIG. 5), identify a class or pool of potential target recipients in proximity to vendor for vendor to choose amongst, and/or request vendor to identify characteristics of potential target recipients.

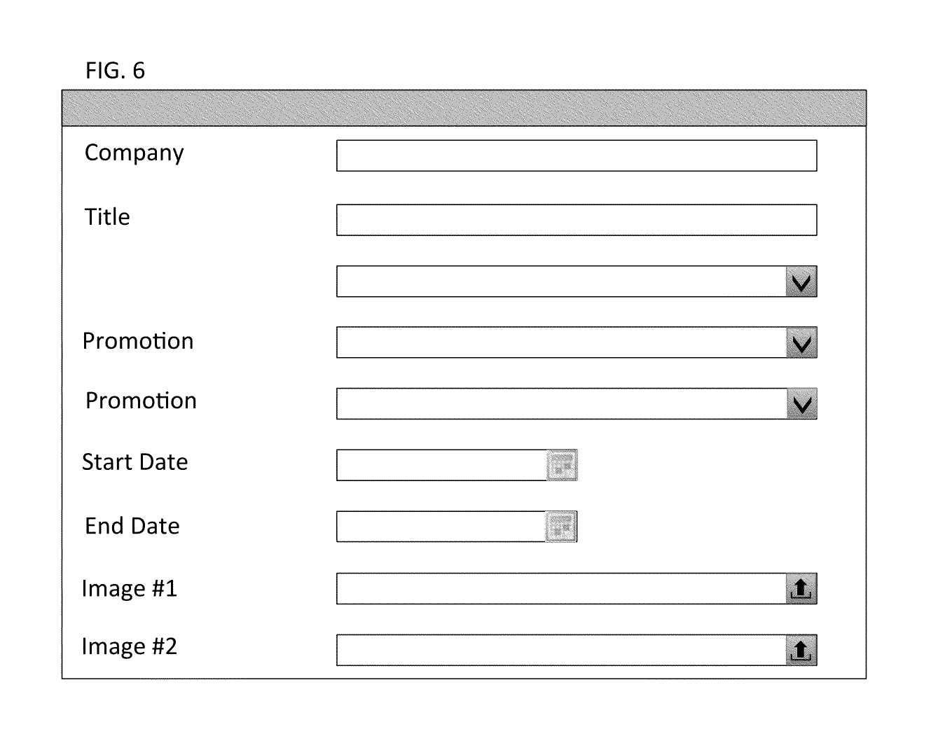

The promotion preferably includes at a minimum such terms as are sufficient (for example, legally, summarily, etc.) to define the offer that a transactions represents, or more generally a description to suffice as an advertisement. Accordingly, the template, as illustrated in FIG. 6, will request information such as a product description and/or the price and/or discount to be applied, maximum and/or minimum value, exclusions, vendor description, etc. Information can be input freeform or as predetermined or pull-down items to limit the available choices. If the transaction is for entry or admission for an event or venue, the relevant information in the promotion can include the purchase price, the date, and the name or identifier for the event or venue. If only certain merchants or locations will honor an offer, for example, specific franchisees, that information also will be included. Offer information also may include expiration dates, limits, and other terms and conditions imposed by a vendor. In addition to information supplied by the vendor, the system may generate information to assist in the prosecution of the promotion. For example, the system may generate or include a transaction identifier that may be unique to a particular recipient and/or member, transaction or transaction type, the vendor, and the like. The system may also generate offer codes to assist in tracking the effectiveness of campaign, and usually will include such codes if a manufacturer, franchisor, or other third party will reimburse a vendor who honors the electronic transaction. System may also comprise a guide, wizard or template for vendors to input promotions.

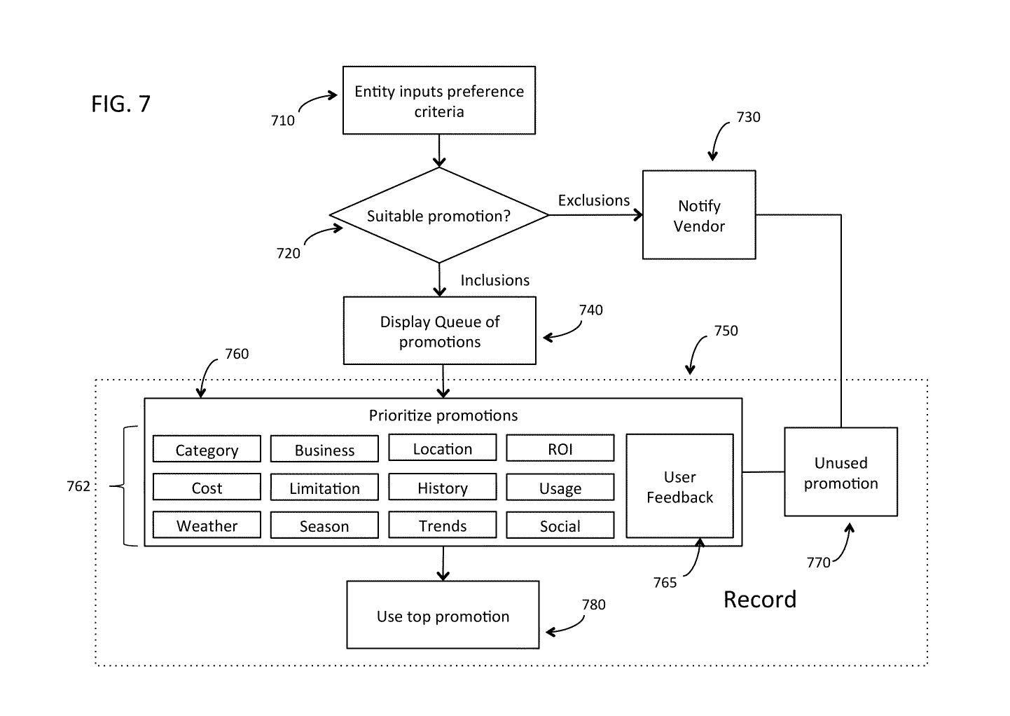

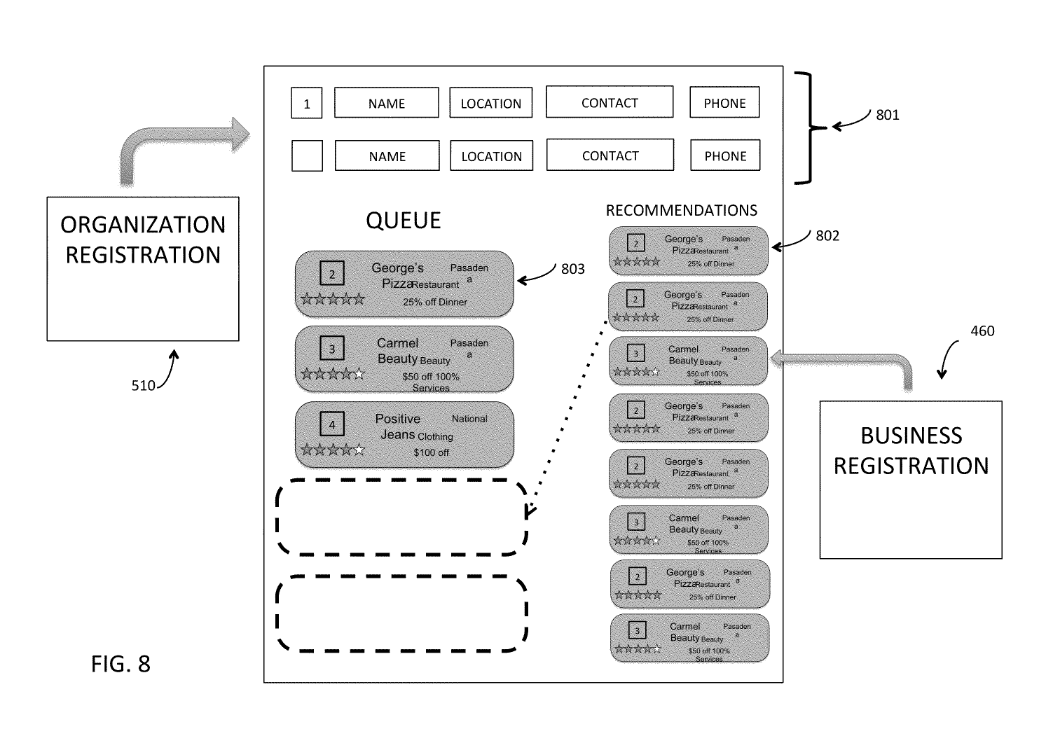

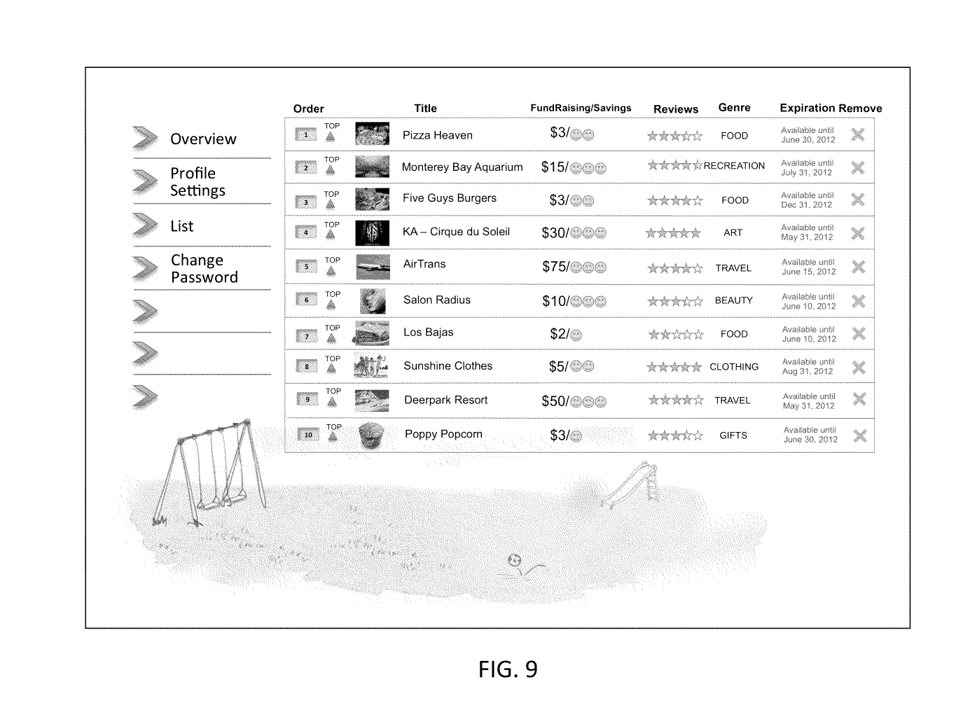

FIG. 7 illustrates the process for determining the priority of promotions on the invention queue 100. An entity, such as a person or a person representing a company, non-profit, for-profit, school, church, network, or such other organization with a following or members can initially prefilter promotions by establishing preferences or exclusions 710 that limit the types or number of promotions. For example, many non-profits and community organizations will not want to see adult content on their queue. Other types of promotions, although suitable, may be screened 720 based on location or other such factors. If certain promotions are excluded, the originating vendor can be notified 730 of the exclusion to modify the promotion to be suitable. One or more suitable promotions can be displayed 740 on invention queue. The queue 100 will evolve 760 to accommodate the desires of the user (or the audience) and the expended promotions. The queue can be reprioritized 760 manually by the user of the system or automatically by the system. For example, as shown in FIG. 8, a user can drag-and-drop promotions from a pool of possible promotions or move a promotion from one priority position to another position. Alternatively, or in addition, promotions can be displayed as a list of promotions, prioritized and reordered from one position to another, as shown in FIG. 9., similar to queues for online movie rentals (Netflix.com™ or Blockbuster.com™)

Factors 762 that may affect the priority include information about the promotion such as the category, the business, the location of the business or the promotion, seasonal or environmental conditions such as weather, trends and vogues, the history of the promotion, the cost, any limitations for the promotion (such as the expiration dates or the range of usable dates or limited number of uses or maximum spend or such other limitation), the usage (or non-use 770) of the promotion by other venues or users, social influences such as recommendations or criticisms, and the like. If used as a fundraiser, the amount of return to the user may be of some value. User feedback 765 will also be valuable. Factors can be both positive to increase the priority or negative to decrease the priority, even exclusionary. An entity may desire to limit redundant or repetitive use, for example, a promotion in one location may be active in parallel in a remote location, or it may be desirable to have a certain period of time between the activation of a promotion and the reactivation of that same promotion.

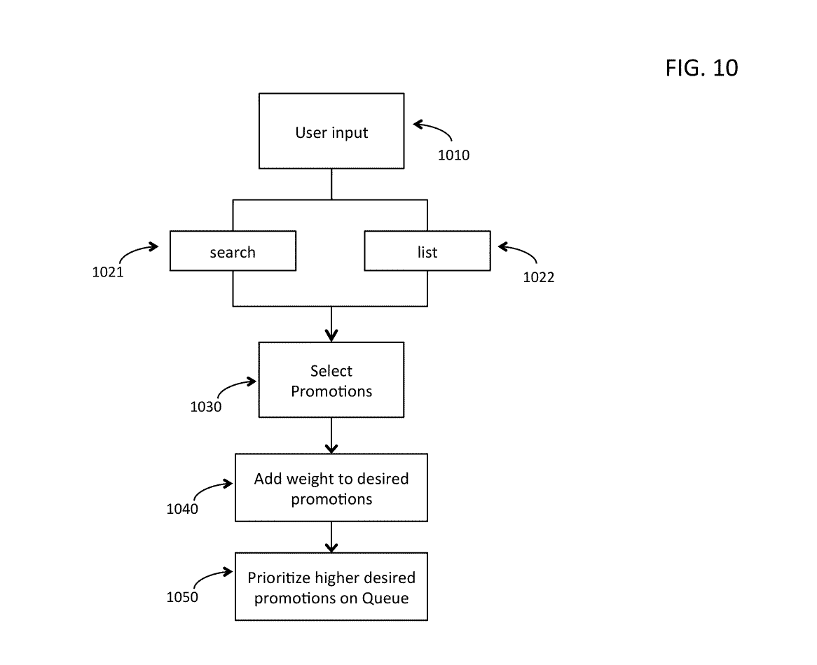

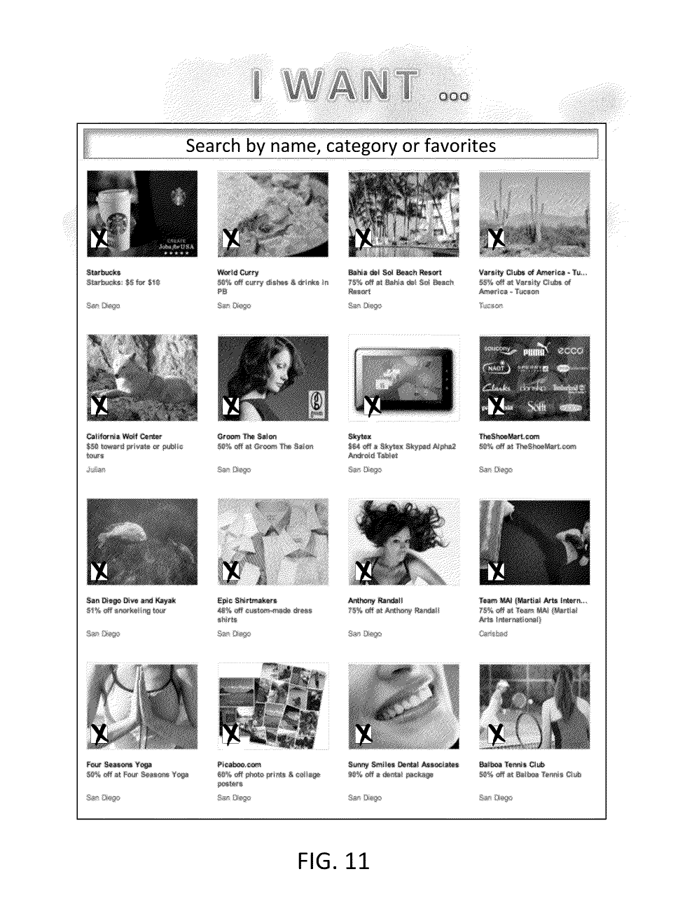

It may be desirable to automate the process of prioritizing promotions. One manner of automating the prioritization of promotions is to engage the end user, the audience, as shown in FIG. 10. FIG. 10 illustrates a process by which the audience will provide input 1010 to the invention system by adding weight, directly or indirectly, to particular promotions or classes of promotions. The audience may show interest (or disinterest) to particular promotions or classes of promotions by directly choosing 1010 such promotion(s), for example by searching for 1020 or identifying 1025 particular promotion(s). An individual can increase the priority of a promotion or class of promotions by selecting particular promotion(s) 1030, with each vote adding greater weight 1040 to the one or more promotions. If a significant number of individuals vote for such promotion(s) 1030 then greater priority 1040 is given to that promotion or class of promotions, increasing its rank. Alternatively, as discussed above, priority by audience can be for particular categories of promotions, such as food or theater, or a particular type of food such as coffees or French food. Other factors that audience may request include location, cost or cost range, recommendations from peers or other users, usage and history, affiliations to particular organizations, and the like. Audience can search for particular promotions or classes of promotions, or be provided lists or groupings of promotions, or categories to choose from. It is contemplated that the present invention may utilize multiple factors in determining prioritizations, including learning from the prioritization and usage history. FIG. 11 shows a grid of specific promotions individuals can select or vote for, although it is contemplated that the promotions in FIG. 11 can be readily substituted by categories such as restaurants, clothing, music, arts, water sports, etc. The prioritization of the promotions will generally be over a fixed period of time, such as an hour or several hours, a day or days, or a week, month, year, etc. Alternatively, the prioritization can be immediate, so as to create an instant collective bargaining mechanism for more than one user to create an instant promotion by showing strong interest in a promotion. Preferably, the higher the value or stronger the interest will automatically reprioritize the promotions on invention queue.

It is contemplated that at certain fixed points, the top promotion or promotions will be distributed to the audience for their view and use. Promotions can be distributed directly or indirectly by the system. System can transmit the promotion to recipient through a multitude of platforms, including email, SMS or other text message, twitter or other electronic message. It will be appreciated that the offer or promotion can be presented to user in a variety of means, including verbal, telephonic, TV or radio, mobile, electronic or written, including such methods as email, text, flyers, requests, social media tools, newsletters, advertisements, and the like. Generally, however, many recipients are hesitant to release their membership or distribution list, and prefer to send out any information to their members directly. Accordingly, in one preferred embodiment, the entity can directly send promotion information to its members and affiliates. This information can be sent intact, in summary (or certain portions of the promotion such as the vendor, type, discount, etc.) or represented, for example, as a website address or link directed to the promotion. Alternatively, many recipients may not have the means and resources for transmitting electronic promotions, and would require the system to transmit promotions. Preferably, the system contemplates storing recipient member information on the system.

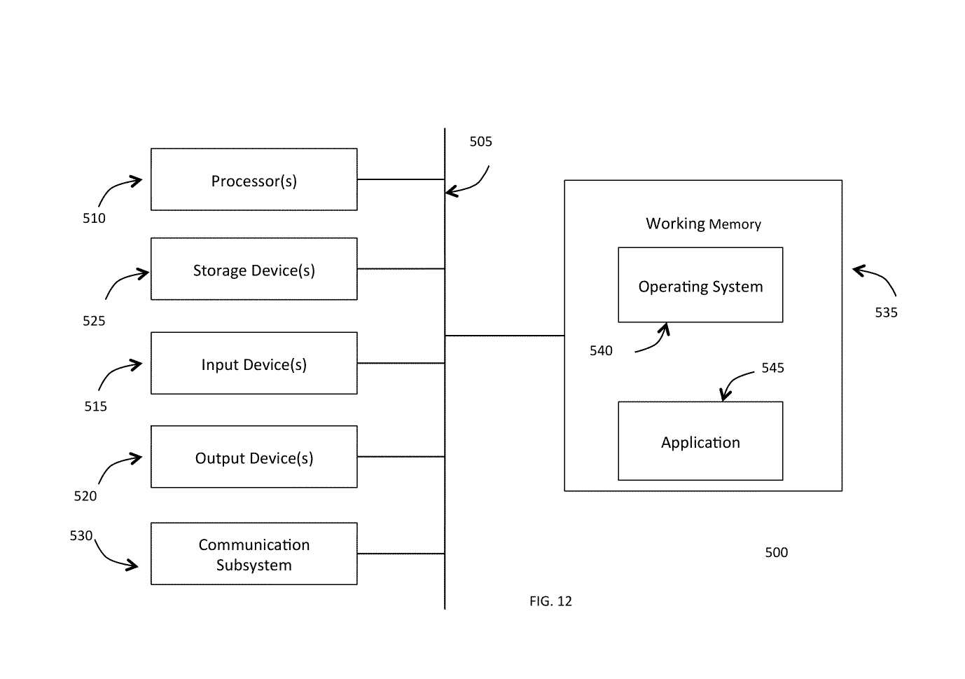

Reference is now made to FIG. 12, which is a block diagram illustrating a computer system 1200 that is able to perform the invention methods.

It should be noted that FIG. 12 is meant only to provide a generalized illustration of various components, any or all of which may be utilized as appropriate. FIG. 6, therefore, broadly illustrates how individual system elements may be implemented in a relatively separated or relatively more integrated manner.

The computer system 1200 is shown comprising hardware elements that can be electrically coupled via a bus 1205 (or may otherwise be in communication, as appropriate). The hardware elements can include one or more processors 1210, including without limitation, one or more general purpose processors and/or one or more special purpose processors (such as digital signal processing chips, graphics acceleration chips, and/or the like); one or more input devices 1215, which can include without limitation a mouse, a keyboard and/or the like; and one or more output devices 1220, which can include without limitation a display device, a printer and/or the like.

The computer system 1200 may further include (and/or be in communication with) one or more storage devices 1225, which can comprise, without limitation, local and/or network accessible storage and/or can include, without limitation, a disk drive, a drive array, an optical storage device, a solid state storage device such as a random access memory (“RAM”) and/or a read-only memory (“ROM”), which can be programmable, flash updateable and/or the like. The computer system 1200 might also include a communications subsystem 1230, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 1230 may permit data to be exchanged with a network (such as the network described below, to name one example), and/or any other devices described herein. In many embodiments, the computer system 600 will further comprise a working memory 1235, which can include a RAM or ROM device, as described above.

The computer system 1200 also can comprise software elements, shown as being currently located within the working memory 1235, including an operating system 1240 and/or other code, such as one or more application programs 1245, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1225 described above. In some cases, the storage medium might be incorporated within a computer system, such as the system 1200. In other embodiments, the storage medium might be separate from a computer system (i.e., a removable medium, such as a compact disc, etc.), and is provided in an installation package, such that the storage medium can be used to program a general-purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 1200) to perform methods of the invention. According to a set of embodiments, some or all of the procedures of such methods are performed by the computer system 1200 in response to processor 1210 executing one or more sequences of one or more instructions (which might be incorporated into the operating system 1240 and/or other code, such as an application program 1245) contained in the working memory 1235. Such instructions may be read into the working memory 1235 from another machine-readable medium, such as one or more of the storage device(s) 1225. Merely by way of example, execution of the sequences of instructions contained in the working memory 1235 might cause the processor(s) 1210 to perform one or more procedures of the methods described herein.

The terms “machine-readable medium” and “computer readable medium,” as used herein, refer to any medium that participates in providing data that causes a machine to operate in a specific fashion. In an embodiment implemented using the computer system 1200, various machine-readable media might be involved in providing instructions/code to processor(s) 1210 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 1225. Volatile media includes, without limitation, dynamic memory, such as the working memory 1235. Transmission media includes coaxial cables, copper wire and fiber optics, including the wires that comprise the bus 1205, as well as the various components of the communications subsystem 1230 (and/or the media by which the communications subsystem 1230 provides communication with other devices). Hence, transmission media can also take the form of waves (including without limitation radio, acoustic and/or light waves, such as those generated during radio wave and infrared data communications). A non-transitory computer readable medium refers to a machine or computer readable medium but does not necessarily include a transitory signal per se.

Common forms of physical and/or tangible computer-readable media include, for example, a floppy disk, a flexible disk, a hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 1210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1200. These signals, which might be in the form of electromagnetic signals, acoustic signals, optical signals and/or the like, are all examples of carrier waves on which instructions can be encoded, in accordance with various embodiments of the invention.

The communications subsystem 1230 (and/or components thereof) generally will receive the signals, and the bus 1205 then might carry the signals (and/or the data, instructions, etc., carried by the signals) to the working memory 1235, from which the processor(s) 1210 retrieves and executes the instructions. The instructions received by the working memory 1235 may optionally be stored on a storage device 1225 either before or after execution by the processor(s) 1210.

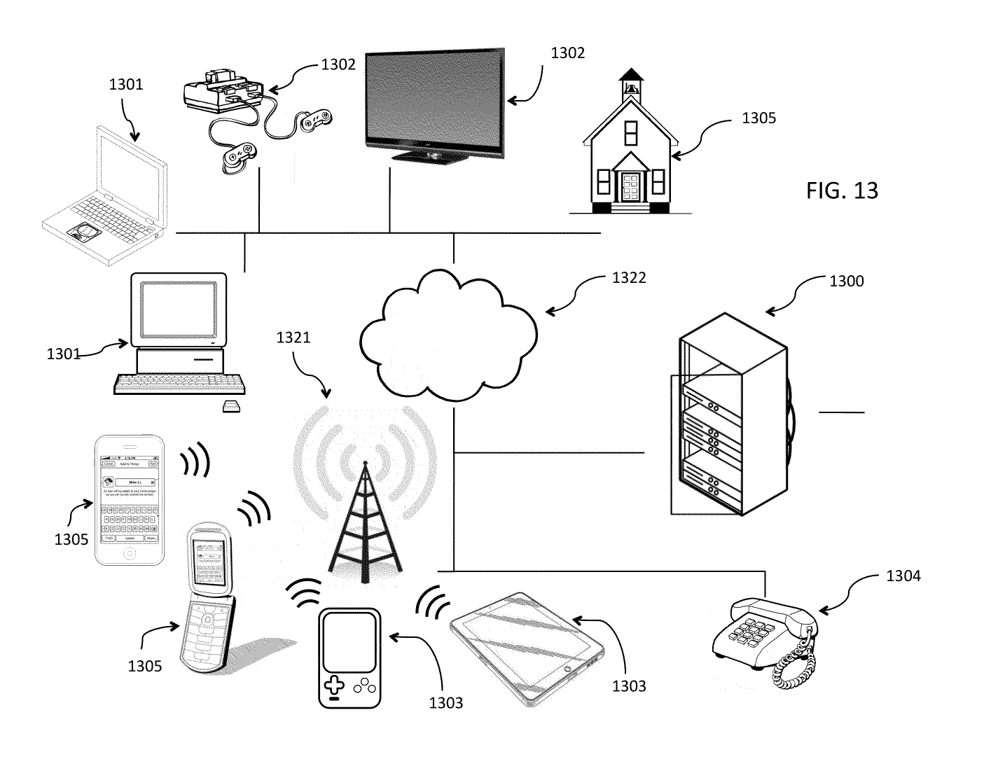

Reference is now made to FIG. 13, which is a schematic drawing illustrating devices and computer systems accessing the invention methods.

The system 1300 can include one or more user computers 1305. The user computers 1301 can be general purpose personal computers (including, merely by way of example, personal computers and/or laptop computers running any appropriate flavor of Microsoft Corp.'s Windows' and/or Apple Corp.'s Macintosh' operating systems) and/or workstation computers running any of a variety of commercially available UNIX™ or UNIX-like operating systems. These user computers 1301 can also have any of a variety of applications, including one or more applications configured to perform methods of the invention, as well as one or more office applications, database client and/or server applications, and web browser applications. Alternatively, the user computers 1301 can be any other electronic device, such as a thin-client computer, media computing platforms 1302 (e.g., gaming platforms, or cable and satellite set top boxes with navigation and recording capabilities), handheld computing devices (e.g., PDAs, tablets or handheld gaming platforms) 1303, conventional land lines 1304 (wired and wireless), mobile (e.g., cell or smart) phones 1305 or tablets, or any other type of portable communication or computing platform (e.g., vehicle navigation systems), capable of communicating via a network (e.g., the network 1320 described below) and/or displaying and navigating web pages or other types of electronic documents. Although the exemplary system 1300 is shown with two user computers 1301 and three user phones 1305, any number of user phones, computers, or other devices can be supported.

Certain embodiments of the invention operate in a networked environment, which can include a network 1320. The network 1320 can be any type of network familiar to those skilled in the art that can support data communications using any of a variety of commercially available protocols, including without limitation TCP/IP, SNA, IPX, AppleTalk, and the like. Merely by way of example, the network 1320 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infrared network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 600. Each of the server computers 600 may be configured with an operating system, including without limitation any of those discussed above, as well as any commercially (or freely) available server operating systems. Each of the servers 600 may also be running one or more applications, which can be configured to provide services to one or more clients 701, 705, and/or other servers.

Merely by way of example, one of the servers 600 may be a web server, which can be used, merely by way of example, to process requests for web pages or other electronic documents from user computers 701 or communication devices 705. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 701 or communication devices 705 to perform methods of the invention.

The server computers 600, in some embodiments, might include one or more application servers, which can include one or more applications accessible by a client running on one or more of the client computers 701 or communication devices 705 and/or other servers. Merely by way of example, the server(s) 600 can be one or more general purpose computers capable of executing programs or scripts in response to the user computers 701 or communication devices 705, and/or other servers, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computers 701 or communication devices 705, and/or another server. In some embodiments, an application server can create web pages dynamically for displaying the information in accordance with embodiments of the invention. Data provided by an application server may be formatted as web pages (comprising HTML, Javascript, etc., for example) and/or may be forwarded to a user computers 701 or communication device 705 via a web server (as described above, for example). Similarly, a web server might receive web page requests and/or input data from a user computers 701 or communication devices 705 and/or forward the web page requests and/or input data to an application server. In some cases a web server may be integrated with an application server.

Server generally includes a database of consumer profiles, a database of recipient profiles, a database of vendor profiles, an affiliation database, a promotions database, a communication gateway, an authorization and queue application, and the like. Optionally, server may contain additional features such as a database of potential consumers, non-profits or schools, businesses, manufacturers; financial tools, a customer relationship manager (CRM), a neural network or other data-mining tools to extract information from the server. Alternatively or additionally, server may access another server or other processing or memory means for any or all of these functions or features. Server may be accessed by a web interface. For example, a user may input a mobile phone number in a web banner as a method of initiating a purchase of a mobile device download, for instance a ringtone, game, picture, video, or other download. The account may include billing information. In the event that no previously formed account, the web interface may direct the user to set-up an account, by for instance creating a new web interface or redirecting the existing web interface.

In one preferred embodiment, the system preferably includes a database for storing information that can be valuable for storing information about the participants (users, vendors and/or audience) and the promotions, as well as any information associated with the promotions, for example the activities associated with the promotions, the most viewed, the most utilized, proximity to audience member, etc.

The database preferably also includes vendor information. The vendor information preferably includes general information regarding businesses, such as industries, locations, target demographics, sales, prior promotions, employees or authorized users, and the like. As vendors utilize the system, information typically stored in the vendor information of the server database, for example, can include such information as promotional sales incentives and deals that are setup between the system and the vendors for contributions to participating recipients within the fundraising system. The promotions and deals preferably include any manner in which the vendors believe they can contribute to the participating recipients which include, but are not limited to, accepting predetermined dollar amounts added to bills for services provided, donating a portion of each purchase to the participating recipients, donating a specific amount per members/users making a purchase with a redeemable coupon, or merely providing a better or reduced price for members/users within the community to help participating recipients.

The vendor database may also include administrative management tools to provide statistical information regarding the value of specific promotions, purchase history and trends, tracking of redeemed transactions such as redeemed discounts and coupons that are taken advantage of by consumers, and an overall usage by recipients and vendors of the fundraising system. The statistical information stored within the vendor database provides data to show what promotional sales incentives the members are utilizing for saving money for the participating recipients with the fundraising system. The database also advantageously provides overall historical background for the vendor to appreciate additional business created with participating recipients through the fundraising system.

For entities, the system preferably also includes a database that stores general information of any transactions processed through the invention queue, and the parties involved. The information preferably includes general information about entity and its audience such as location such as city, state, zip code and regional affiliations (e.g., school districts), type of organization (e.g., non-profit, school or charitable organization, and more specifically e.g., primary or secondary school, law enforcement foundation, environmental group, church, etc.), general characteristics of its audience (e.g., parents of elementary schools, donors of non-profit, members of church, parents of school band, etc.), specific membership information such as audience contact information (e.g., email, cell phone, social media contact information such as Twitter or Facebook or such other information), and the like.

The system also preferably stores transaction information pertaining to the queue system. Information relevant to the vendor such as purchased transactions, redeemed transactions, statistical information such as most fruitful transaction, demographics information, and the like may be tracked and viewed by vendor through a specific portal created for each vendor. Similarly, similar portals can be created for the user, their audience if any or other consumers registered with the site with respect to their transaction information and related statistics relevant to each entity. For example, the typical acquisition data stored within the system can include, but is not limited to, the amount spent by each audience and the category of most viewed and/or activated promotions. The statistical information found in the data 339 can advantageously be used by the system to provide information to the user (if an entity, their audience) and the vendors 611, to show trends.

It is further contemplated the system may be used actively identify consumer preferences or trends. Many marketing systems are available that identify consumer information such as location and demographics upon the purchase of a product or service. Such data mining tools are readily available to mine, for example, the credit card purchasing habits of an individual based on their marketing target characteristics such as location, demographics, etc. Very few tools actively test the purchasing habits of consumers by actively promoting multiple promotions, and learning behavior as they relate to the consumers affiliations with a particular organization (e.g., a recipient) and the recipients characteristics. Accordingly, the present invention further describes a method and system for actively testing consumer behavior, preferences and trends based on affiliations to an organization. The system may be used to assay multiple promotions from a vendor(s) presented to multiple consumers (generally as they are affiliated with a particular recipient or a group of recipients). Alternatively, multiple promotions (same or similar can be from different vendors). Preferably, the promotions are closely related such as from the same vendor, same type of service or product, location, generally the same deal packaged in multiple ways (e.g., $50 for $100 of services or 50% discount for $100 or Buy One $50 certificate Get One $50 certificate free), different colors, or such other closely related yet trackable promotions. Preferably, the promotions are different in one characteristic or another, or for example, services.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein with reference to the use of conventional landlines and cellular phones. It will be understood, however, that the invention is not so limited. That is, embodiments are contemplated in which a much wider diversity of communication devices may be employed in various combinations to effect redemption.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A promotion prioritization system, comprising at least one computer readable medium having computer executable instructions stored therein, wherein the computer executable instructions are configured to receive one or more promotions that are displayed for a user, and to prioritize the promotions based on the interest of one or more individuals.

2. The promotion prioritization system of claim 1, wherein promotion prioritization system further is further configured to transmit and display prioritized promotions to the individuals.

3. The promotion prioritization system of claim 1, wherein the promotions are displayed visually, graphically or textually to the user of the system

4. The promotion prioritization system of claim 3, wherein the user is a representative of an entity.

5. The promotion prioritization system of claim 4, wherein the individual is a member of the entity.

6. The promotion prioritization system of claim 1, wherein prioritization system is further configured for vendors to enter promotions.

7. The promotion prioritization system of claim 6, wherein promotions are consumer incentivizes consumers to acquire or receive a good, service or product.

8. The promotion prioritization system of claim 7, wherein the promotion is selected from a sales incentive, rebate, voucher, gift certificate, coupon, advertisement, donation, raffle, auction, freebie, and discount.

9. The promotion prioritization system of claim 1, wherein promotions are displayed to user by relevance or interest to the individuals.

10. The promotion prioritization system of claim 1, wherein promotions are manually prioritized by the user based on the interest of the user or a larger audience.

11. The promotion prioritization system of claim 10, wherein promotions are prioritized based on the geographic segmentations, demographic/socio-economic segmentation, psychographic segmentation, behavioral segmentation, product-related segmentation, affiliations or relationships of the individuals.

12. The promotion prioritization system of claim 5, wherein prioritized promotions are prefiltered based on relevance to user, the entity or its members.

13. The promotion prioritization system of claim 1, wherein the order of the promotions can be automatically affected by the desires or activity of the individuals.

14. The promotion prioritization system of claim 13, wherein promotions are prioritized based on the geographic segmentations, demographic/socio-economic segmentation, psychographic segmentation, behavioral segmentation, product-related segmentation, affiliations or relationships of the individuals.

15. The promotion prioritization system of claim 1, wherein the individuals vote to affect the priority of the promotions.

16. The promotion prioritization system of claim 15, wherein the priority of the promotions are weighted by the history, value, recent usage, demand, or proximity of the promotions.

17. The promotion prioritization system of claim 2, wherein promotion prioritization system is further configured to transmit promotions to the individuals triggered by the demand by the user or the individuals or on fixed time intervals.

18. The promotion prioritization system of claim 5, wherein the promotions displayed to the individual is prioritized based on the relevance or interest of the members of the entity.

19. The promotion prioritization system of claim 1, further comprising one or more memory storage devices for storing and displaying one or more promotion and one or more memory storage devices for identifying the interest of one or more individuals.

20. A system for managing promotions across multiple promotion queues, wherein promotions are distributed amongst two or more promotion prioritization systems of claim 1.
